(19) United States
(12) Patent Application Publication
(10) Pub. No.: US 2009/0101753 A1
(43) Pub. Date: Apr. 23, 2009

(54) Device for compensation of the Tail rotor in a helicopter

(76) Inventors: Shahin Kassai, Tehran (IR); Rustom Dinyariyan, Tehran (IR)

Correspondence Address: BARRY CHOOBIN, 193 SUITE #18, TALEGHANI, BAHARE SHOMALI, TEHRAN, 1563714311, IR

(21) Appl. No.: 11/875,838

(22) Filed: Oct. 20, 2007

(51) Int. Cl. B64C 27/82

(52) U.S. Cl. 244/17.19

(57) ABSTRACT

According to the present invention, In case of tail rotor failure in a helicopter, pilot will activate Cockpit control unit which is installed in cockpit, wherein said unit contains activation switch and electronic circuits that automatically performs steps of: determining and releasing a predetermined pressurized gas from a capsule, wherein said capsule is located within the helicopter, and wherein said predetermined pressurized gas is based on a level of pressure in said capsule, and feedback received form yaw movement; and thereby compensating tail rotors torque and stabilizing said helicopter.

### BACKGROUND OF THE INVENTION

### Field of the Invention

This invitation relates to helicopters, and more particularly to stabilizing the helicopter in critical situation.

As is known, one typical type of helicopter has a main rotor which provides lift and forward thrust in response to torque provided thereto through rotary power means, including an engine, in a manner determined by the pitch angle of the rotor blades. In order to stabilize the airframe against rotation as a consequence of the torque applied by the engine to the main rotor, this type of helicopter has a tail rotor, the rotary speed of which is a fixed, geared function of the speed of the main rotor. The angle of the tail rotor blades, in addition to being adjustable to provide maneuvers in yaw, is adjusted to provide thrust to apply torque to the airframe, about a yaw axis, which will compensate for the torque applied by the engine to the main rotor, so that the airframe will be rotationally stable (rather than tending to rotate under the rotor). Control over the amount of compensating thrust provided by the tail rotor is achieved by varying the tail rotor blade pitch angle as a function of the amount of collective pitch angle of the main rotor blades. Thus, the tail rotor blade angle pitch beam is provided with a command component which bears a fixed ratio to the collective pitch command to the main rotor, referred to as collective/tail pitch mixing.

Controlling yaw is essential in preventing the helicopter from spinning out of control. An inherent aspect of controlling the yaw of a single rotor helicopter is the counteraction of the torque generated in driving the main rotor of the helicopter. This torque tends to rotate the entire helicopter in a direction opposite to the rotation of the main lifting rotor. Said torque is generated by the resistance of the air to the driving of the rotor.

In most types of helicopters, the propulsive force is provided by main lifting rotor and rotor blades, while yaw control has generally been provided by a second and smaller stabilizing rotor located at the rear or tail of boom. Stabilizing rotor (tail rotor) controls the yaw of helicopter.

Failure of the Tail rotor is one of the main reasons that causes helicopter to crash. In tail rotor failure, helicopter starts spinning around (main rotors shaft) loosing control.

Prior arts tried to solve this problem by fundamental changes in stabilizing system of a helicopter.

Therefore, it would advantageous to have a system that can overcome above shortcomings.

The present invention discloses a new method and a system for compensation of the Tail rotor in the event of failure of the Tail rotor, thus facilitating safe landing without a fundamental change in the stabilizing system of a helicopter.

### SUMMARY OF THE INVENTION

Objects of the invention include providing helicopter engine torque compensation device in emergency conditions.

According to the present invention, In case of tail rotor failure in a helicopter, pilot will activate Cockpit control unit which is installed in cockpit, wherein said unit contains activation switch and electronic circuits that automatically performs steps of: determining and releasing a predetermined pressurized gas from a capsule, wherein said capsule is located within the helicopter, and wherein said predetermined pressurized gas is based on a level of pressure in said capsule, and feedback received form yaw movement; and thereby compensating tail rotors torque and stabilizing said helicopter.

According to another aspect of the present invention, the gas pressure is adjustable and by increasing and decreasing gas flow, directional control is achieved and helicopter yaw can be controlled and the helicopter will turn clock wise or anti clock wise.

Yet in another aspect of the present invention, pressurized gas wherein characterized in that a force is released against propulsive force (spinning vector), said pressurized gas force counteracts propulsive force generated by the main rotor of the helicopter, thereby stabilizing the helicopter.

The gas pressure is adjustable and by increasing and decreasing gas flow, directional control is achieved and helicopter yaw can be controlled and the helicopter will turn clock wise or anti clock wise.

### BRIEF DESCRIPTION OF THE DRAWINGS

FIG. 1 is a functional block diagram of the system. It shows the brief arrangement of the system.

FIG. 2 is a graphical representation that shows the conventional helicopter before installing the nozzle.

FIG. 3 is a graphical representation that shows the conventional helicopter after installing the nozzle.

FIG. 4 is a graphical representation that shows the gas flow direction from top view.

FIG. 5 is a graphical representation that shows the moment arms between main rotor and tail rotor and output nozzle.

FIG. 6 is a graphical representation that shows the force directions. It shows in witch direction the main rotor torque generates and how does gas flow will compensate aforementioned torque.

FIG. 7 is a graphical representation that shows the component arrangement inside the helicopter wherein the gas capsule is located.

FIG. 8 is another variation graphical representation that shows the component arrangement inside the helicopter wherein the gas capsule is located.

FIGS. 9 and 10 are graphical representations that show a mechanism providing heated output gas in order to increase the force.

### DETAILED DESCRIPTION OF THE INVENTION

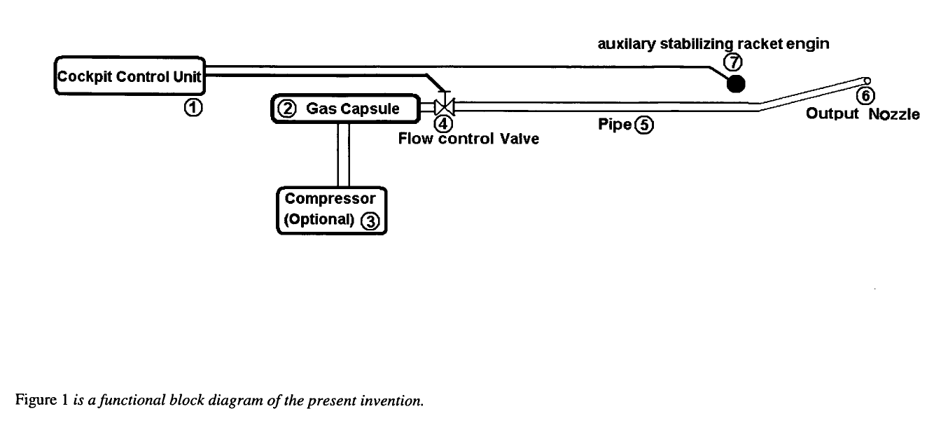

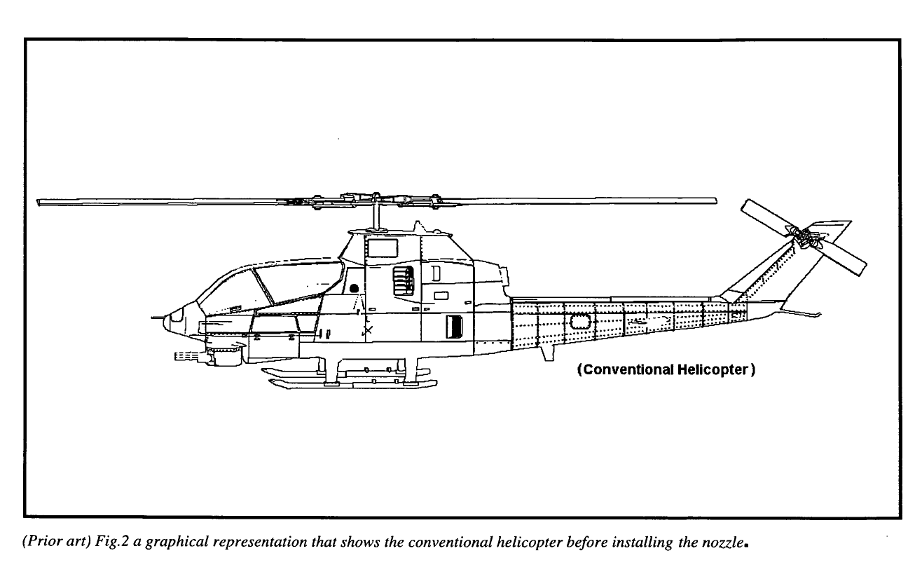

FIG. 1 is a functional block diagram of the system wherein said system comprises a cockpit control unit (1) Cockpit control unit which is installed in cockpit and contains activation switch and electronic circuits that can measure capsule pressure and temperature. Furthermore the unit computes and determines how much pressure is required to control helicopter yaw and consequently, depending on propulsive torque changes the valve output; gas capsule (2); a compressor (3): this unit increases maximum time of system operation. It is noticeable that the air compressor does not impose any force to the main rotor power until an emergency situation and only in an emergency situation uses the main rotors power and it will use the main rotors power to produce gas pressure when more gas pressure is needed. To use this system for longer time an air pump can be added to the system and continuously pumping air pressure in the capsule. However, said capsule must be filled with very high pressure gas because air pump is only auxiliary equipment and can not pressurize air substantially; a flow control valve (4) is the main valve which controls the gas flow and is controlled by cockpit control unit. Electrical valves are the best choice for said valve being reliable and fast and can be controlled easily; a pipe (5) which conducts the gas to the nozzle; an output nozzle (6) which is mounted on the end of the tail boom and its head has a 90 degree knee, releases the pressurized gas; and an auxiliary stabilizing rocket engine (7) wherein said rocket engine is activated in case of tail rotor failure and if an unexpected force imposed to helicopter, using small rocket engine in tail boom and activating said rocket helps the helicopter to retrieve its stability and activating the gas, thereby controlling the helicopter yaw.

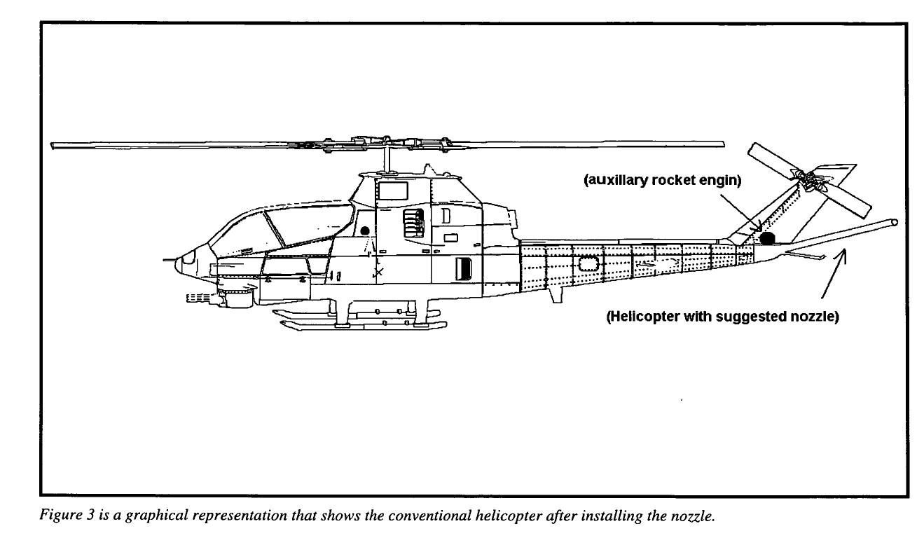

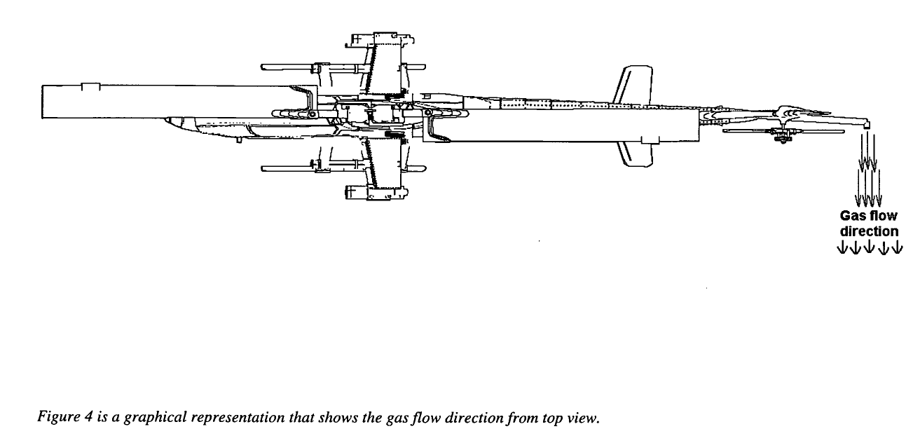

FIG. 3 shows conventional helicopter after installing the nozzle. The Gas flow is directed to the side but sideways thrust does not contribute to the forward thrust of the helicopter but provides a torque-correcting flow. The nozzle is mounted on end of the tail boom and it doesn't affect helicopters aerodynamics.

Nozzle output which is directed to the side has sufficient distance from tail rotor blades to prevent conflict between blades and nozzle.

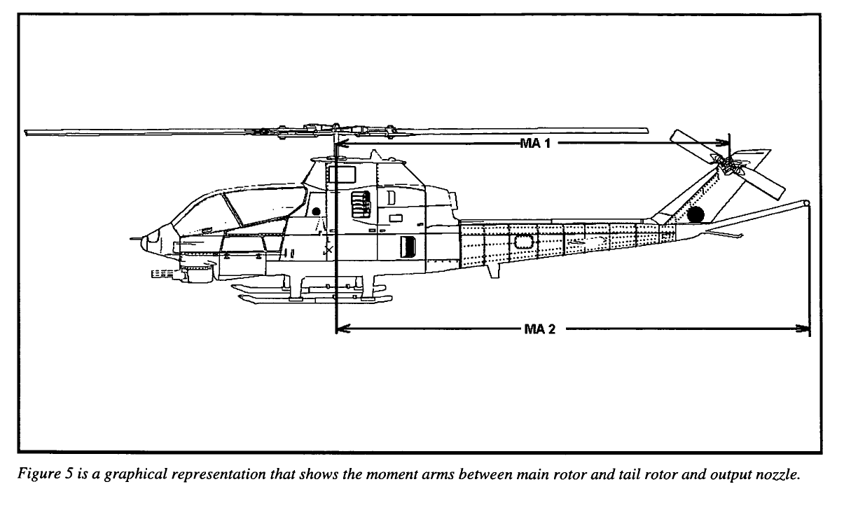

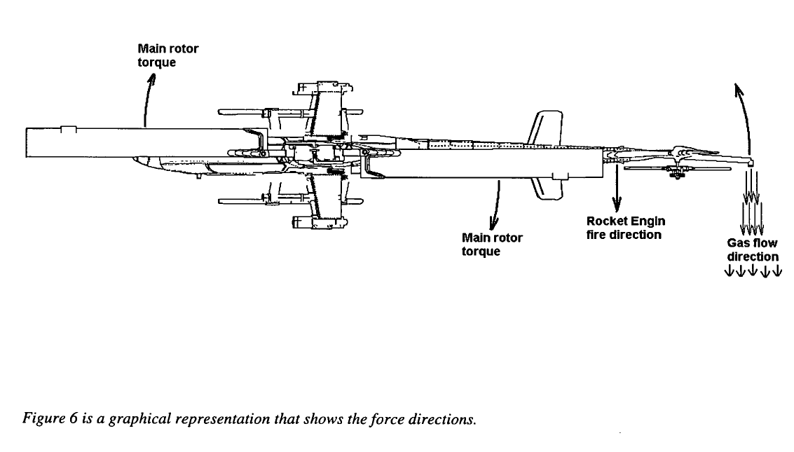

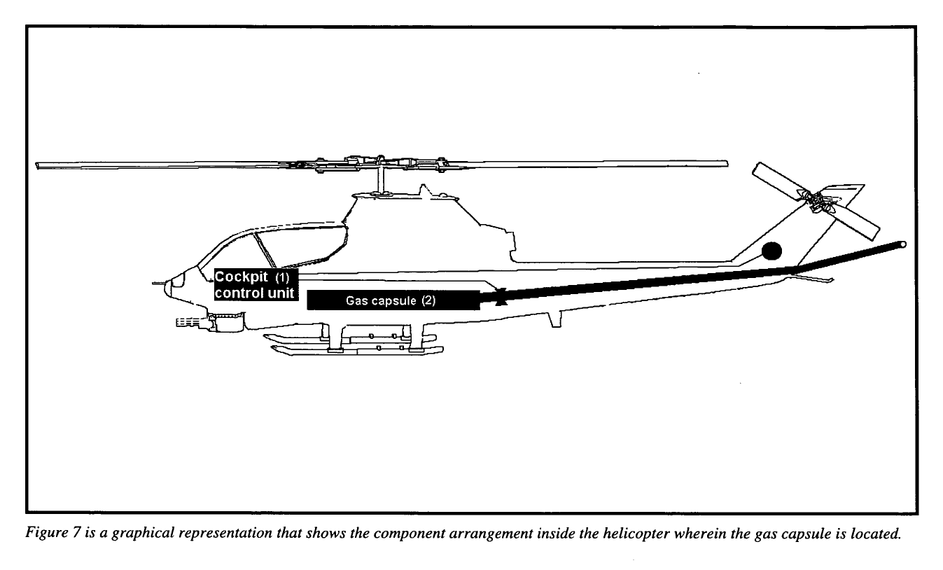

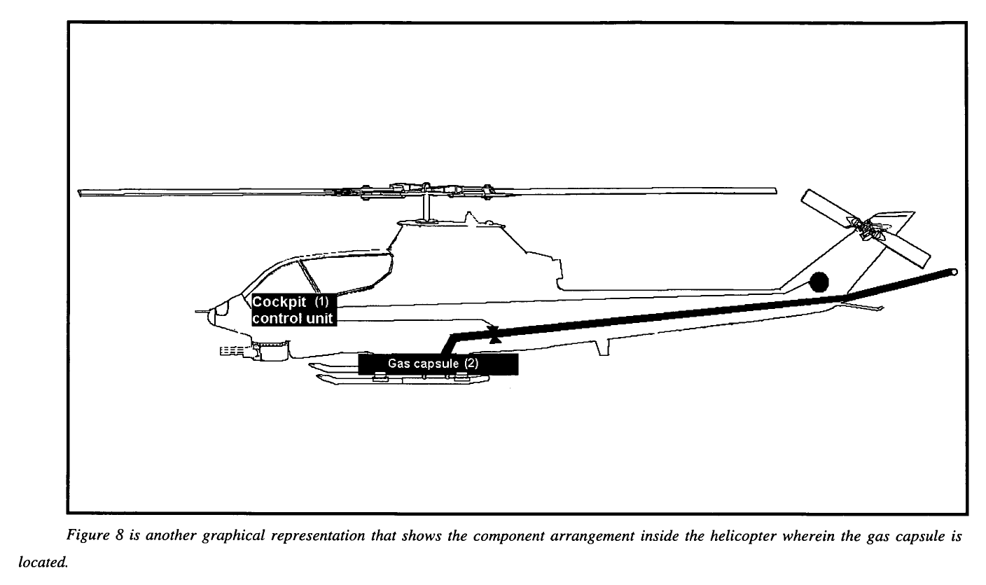

In FIG. 5, when tail rotor is working a moment arm is defined by the distance between main rotor (measured as reference axis), and tail rotor (stabilizing rotor) axis but in another instant when the system is activated, moment arm is defined by the distance between main rotor axis, and head of nozzle. Obviously, in the second instance moment arm is longer than the first one and as result requires less force (gas pressure force), thereby helicopter yaw is controlled.

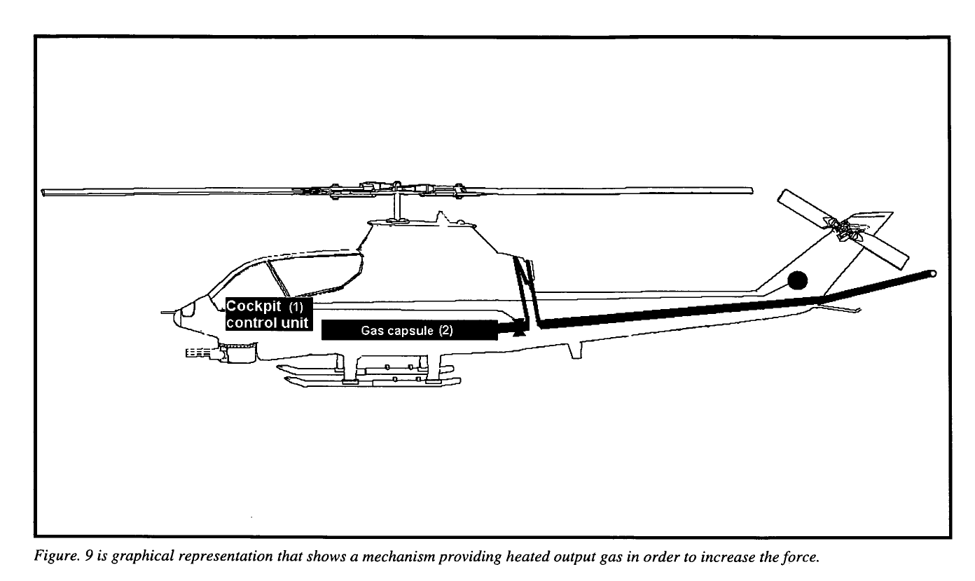

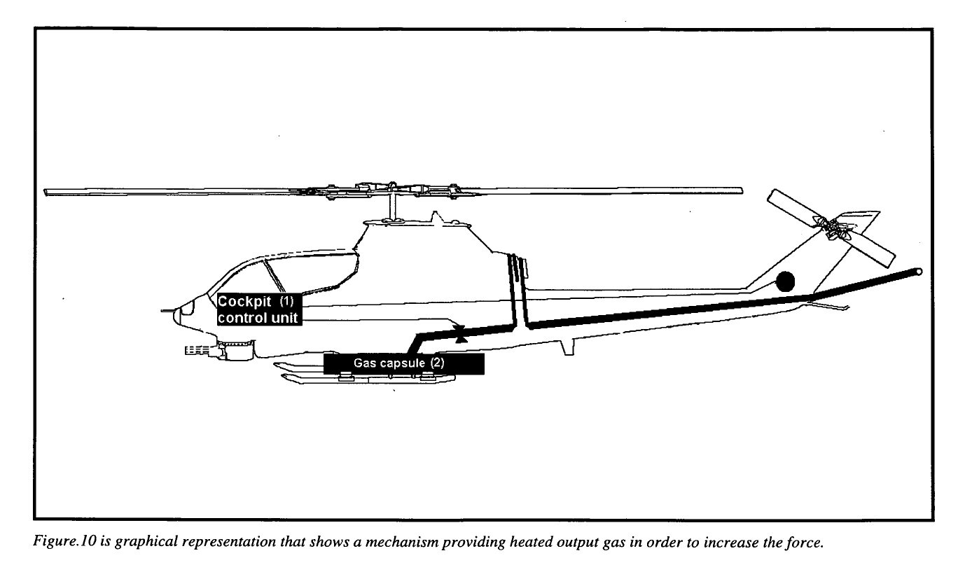

FIGS. 9 and 10, show heating the gas causes more force and easily can be achieved by rolling gas pipe around the exhaust.

Referring back to FIG. 1, in particular the cockpit control unit, during the system activation, when the gas is released, as result the temperature of the capsule containing the gas drops which is in direct relation with the amount of the pressure of said gas. In order to prevent this from happening, the present invention discloses a heater for heating the capsule in order to maintain the appropriate temperature for the capsule and the gas therewith.

The present invention provides various advantageous comprising: substantially low cost in implementing since helicopter structure does not change. This set can be added to the manufactured helicopters, without redesigning the actual helicopter; light weight and easy mounting; capability to upgrade the existing helicopters with the present invention without a substantial modification to the existing helicopter design.

Obviously, other modifications and variation of the present invention may be possible in light of the foregoing teachings. It is therefore to be understood that within the scope of the appended claims the invention may be practiced otherwise than as specifically described.

What is claimed is:

1. A method for compensating a tail rotor in a helicopter comprising steps: activating cockpit control unit which is installed in cockpit, wherein said unit comprises an activation switch and electronic circuits that automatically perform steps of:
Determining and releasing a predetermined pressurized gas from a capsule, wherein said capsule is located within the helicopter, and wherein said predetermined pressurized gas is based on a level of pressure in said capsule, and feedback received form yaw movement, and thereby compensating tail rotors torque and stabilizing said helicopter.

2. The method as claimed in claim 1, further comprising step of:
adjusting said gas pressure by a valve, thereby controlling directional movement of said helicopter according to level of said gas pressure.

3. The method as claimed in claim 1, further comprising step of:
adjusting said gas pressure by a valve, thereby controlling helicopter yaw causing said helicopter to turn clock wise or anti clock wise.

4. The method as claimed in claim 1, wherein said gas pressure characterized in that a force that is released against propulsive force, and wherein said released force counteracts said propulsive force generated by main rotor of said helicopter, thereby stabilizing said helicopter.

5. A system for compensating a tail rotor in a helicopter comprising:
Cockpit control unit located in cockpit wherein said unit comprises an activation switch and electronic circuits, wherein said electronic circuits measure capsule pressure and capsule temperature;
A means for computing and determining amount of pressure required to control helicopter yaw;
At least one gas capsule;
At least one air compressor, wherein said at least one air compressor increases maximum time of system operation by continuously pumping air pressure into the capsule;
At least one flow control valve;
A pipe, wherein said pipe conducts the gas to a nozzle;
an output nozzle wherein said output nozzle is mounted on the end of the tail boom and wherein its head has a 90 degree knee, whereby the pressurized gas released therefrom; and
An auxiliary stabilizing rocket engine wherein said rocket engine is activated in case of tail rotor failure and an unexpected force imposed to said helicopter.

6. A method as claimed in claim 1, further comprising steps of:
pumping stored fuel and stored pressurized gas into combustion chamber;
Mixing said stored fuel and said pressurized gas;
Burning said stored fuel and said pressurized gas;
Producing exhaust gas at high temperature pressure;
Passing said exhaust gas through the nozzle which accelerates the flow.
